(19) United States
(12) Patent Application Publication
(10) Pub. No.: US 2026/0359844 A1
(43) Pub. Date: Nov. 12, 2026

(54) COMPARATIVE MARKET ANALYSIS

(71) Applicant: Commercial Real Estate Exchange, Inc., Playa Vista, CA (US)

(72) Inventors: James Healy-Mirkovich, Playa Vista, CA (US); Mark Roden, Sherman Oaks, CA (US); Oded Noy, Los Angeles, CA (US); Adam Siegel, Playa Vista, CA (US)

(21) Appl. No.: 19/670,406

(22) Filed: May 7, 2026

Related U.S. Application Data
(60) Provisional application No. 63/803,077, filed on May 9, 2025.

(51) Int. Cl. G06Q 30/0201; G06Q 50/16

(52) U.S. Cl. CPC G06Q 30/020141; G06Q 50/16

(57) ABSTRACT

For generating a comparative market analysis, a method trains a comparable property model on property data. The comparable property model includes a graph neural network with nodes and edges. The edges include at least a co-citation comparable edge. The method generates a property graph for a plurality of property descriptions and a given property description using the property model, wherein nearness indicates market similarity. The method identifies comparable properties for the given property based on the market similarity of the comparable properties in the GNN. The method generates a comparative market analysis comprising the comparable properties, property price points, and a property market position based on the comparable properties.

### CROSS-REFERENCE TO RELATED APPLICATIONS

This application claims priority to U.S. Provisional Patent Application No. 63/803,077 entitled “OMNI COMPARATIVE MARKET ANALYSIS” filed on May 9, 2025 for Mark Roden, which is incorporated herein by reference.

### BACKGROUND INFORMATION

The subject matter disclosed herein relates to comparative omni market analysis of real property.

### BRIEF DESCRIPTION

A method for generating a comparative market analysis is disclosed. The method trains a comparable property model on property data. The comparable property model includes a graph neural network with nodes and edges. Each node is one of a property node, a tenant node, an owner node, a broker node, a lender node, a transaction node, a submarket node, a zoning district node, a point-of-interest node, a school district node, an opportunity-zone node, and a macro-market node. The edges include at least a co-citation comparable edge. The method generates a property graph for a plurality of property descriptions and a given property description using the property model, wherein nearness indicates market similarity. The method identifies comparable properties for the given property based on the market similarity of the comparable properties in the GNN. The method generates a comparative market analysis comprising the comparable properties, property price points, and a property market position based on the comparable properties. An apparatus and computer program product performing the method are also disclosed.

### BRIEF DESCRIPTION OF DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a property analysis system;

FIG. 2A is a schematic block diagram illustrating one embodiment of models;

FIG. 2B is a schematic block diagram illustrating one embodiment of property data;

FIG. 2C is a schematic block diagram illustrating one embodiment of comparable information;

FIG. 2D is a schematic block diagram illustrating one embodiment of property data;

FIG. 3A is a schematic diagram illustrating one embodiment of a property graph;

FIG. 3B is a schematic diagram illustrating one embodiment of a graph neural network (GNN);

FIG. 4A is a schematic block diagram illustrating one embodiment of a computer;

FIG. 4B is a schematic diagram illustrating one embodiment of a neural network;

FIGS. 5A-B is a flow chart diagram illustrating one embodiment of a market analysis method;

FIG. 5C is a flow chart diagram illustrating one embodiment of a model training method;

FIG. 5D is a flow chart diagram illustrating one embodiment of a document organization method; and

FIG. 6 is a flow chart diagram illustrating one embodiment of a market analysis method.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but rather mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

Program code for carrying out operations for aspects of the present invention may be written in any combination of one or more programming languages, including an object-oriented programming language such as MATLAB, Python, Ruby, R, Java, Java Script, Julia, Go, Smalltalk, C++, C sharp, Lisp, Clojure, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The computer program product may be shared, simultaneously serving multiple customers in a flexible, automated fashion.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

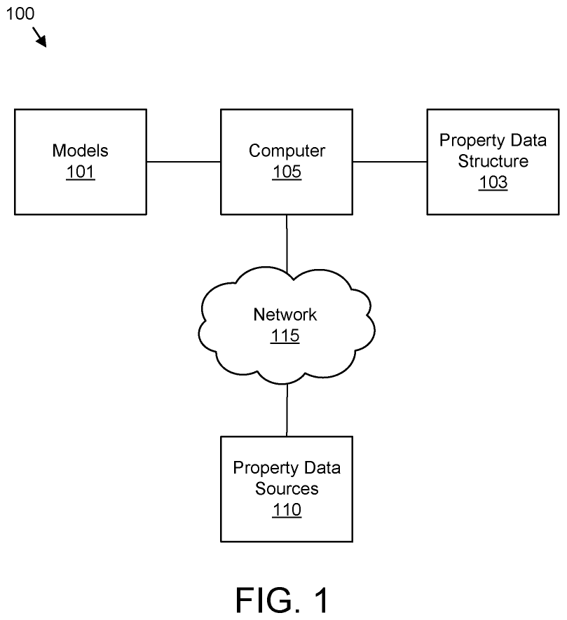

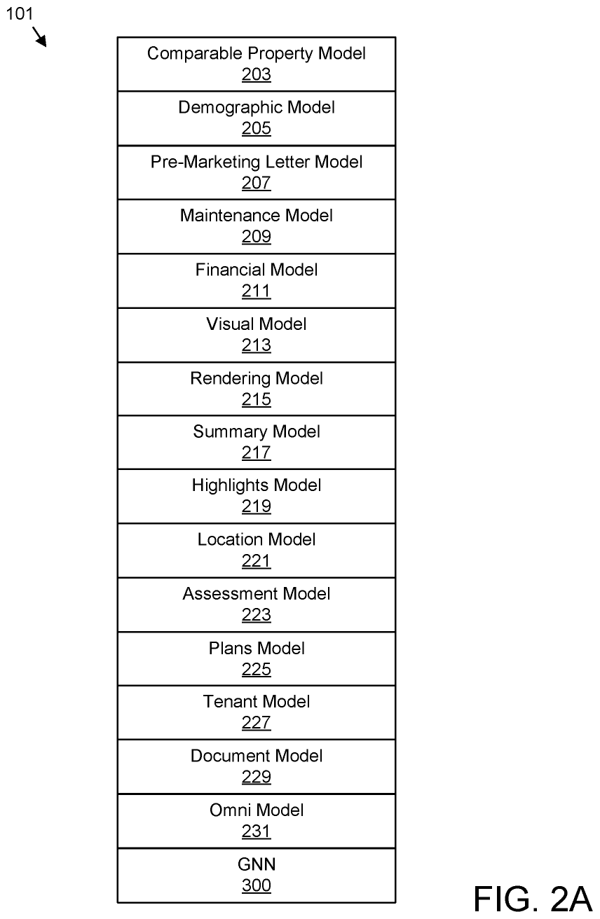

FIG. 1 is a schematic block diagram illustrating one embodiment of a property analysis system 100. The property analysis system 100 may generate a comparative market analysis for real property. In the depicted embodiment, the property analysis system 100 includes a computer 105, a property data structure 103, a network 115, and property data sources 110. In addition, the property analysis system 100 includes at least one model 101.

The property data structure 103 stores information about a plurality of real properties. In one embodiment, the real properties are commercial real properties. The network 115 may be the Internet, a mobile telephone network, a wide area network, a local area network, or the like.

The property data sources 110 may comprise at least one of multiple listing service (MLS) listings, government property records, census data, tax assessment records, geographic information system (GIS) databases, lease agreements, and commercial property records.

The models 101 may guide to computer 105 in accessing the property data sources 110 via the network 115. In addition, the models 101 may guide the computer 105 in organizing information from the property data sources 110 as property data that is stored in the property data structure 103. The models 101 may also guide the computer 105 in generating a comparative market analysis and associated marketing documents from the property data in the property data structure 103 as will be described hereafter.

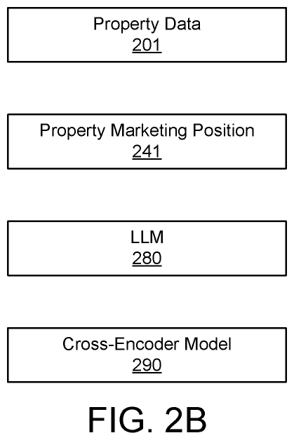

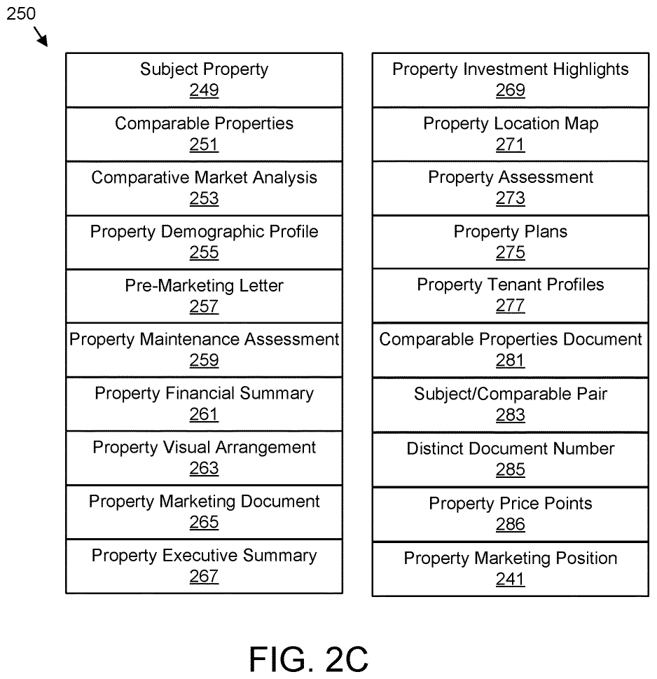

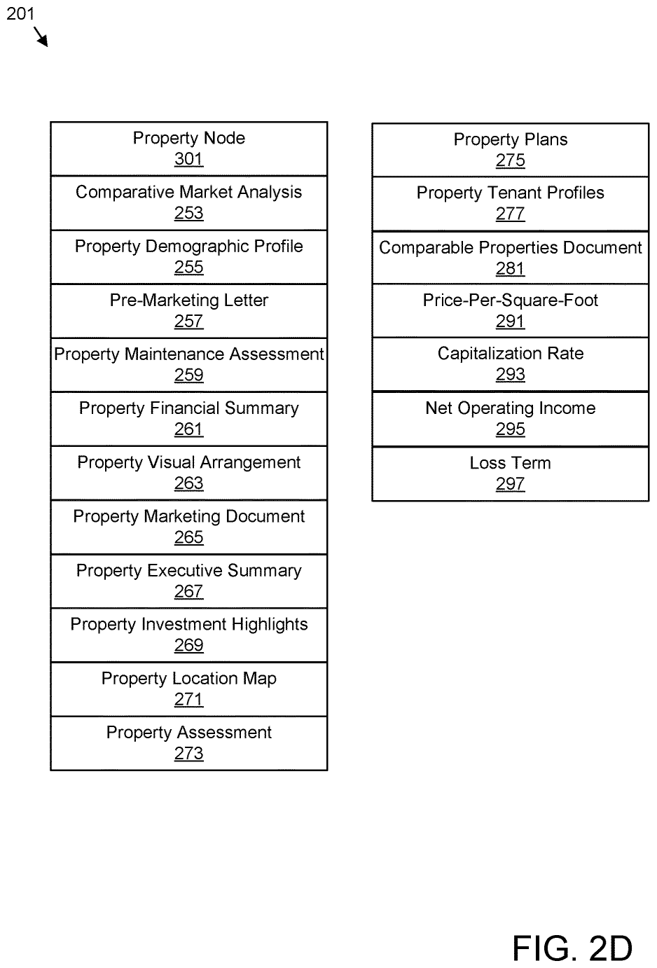

FIG. 2A is a schematic block diagram illustrating one embodiment of the models 101. The models 101 may be organized as a data structure in the memory. In the depicted embodiment, the models 101 include a comparable property model 203, a demographic model 205, a pre-marketing letter model 207, a maintenance model 209, a financial model 211, a visual model 213, a rendering model 215, a summary model 217, highlights model 219, a location model 221, an assessment model 223, a plans model 225, a tenant model 227, a document model 229, an omni model 231, and the GNN 300.

The comparable property model 203 may be trained on comparable training data comprising a plurality of property sets, wherein each property set comprises a pair of property descriptions, a similarity score, price points, and marketing positions.

The demographic model 205 may be trained on demographic training data comprising the marketing positions and demographic data.

The pre-marketing letter model 207 may be trained on pre-market training data comprising the marketing positions, pre-marketing letters, and demographic profiles.

The maintenance model 209 may be trained on maintenance training data comprising condition reports, maintenance records, capital expenditure data, and building system ages.

The financial model 211 may be trained on financial training data comprising net operating income (NOI), cap rate analyses, cash flow projections, investment return metrics, financial statements, rent rolls, operating expenses, market lease rates, cap rate data, current conditions, required repairs, and future expenses.

The visual model 213 may be trained on visual training data comprising the marketing positions, photographs, aerial images, site plans, and reference imagery.

The rendering model 215 may be trained on rendering training data comprising the marketing positions, the demographic profiles, the maintenance assessments, financial summaries, and visual arrangements.

The summary model 217 may be trained on summary training data comprising the marketing positions, the demographic profiles, maintenance assessments, financial summaries, visual arrangements, and executive summaries.

The highlights model 219 may be trained on highlights training data comprising the marketing positions, the financial summaries, and the visual arrangements.

The location model 221 may be trained on location training data comprising the marketing positions, executive summaries, and investment highlights.

The assessment model 223 may be trained on assessment training data comprising the marketing positions, building sizes, parcel information, construction details, zoning information and special features.

The plans model 225 may be trained on plans training data comprising the marketing positions, floor plans, site plans, architectural drawings, and engineering drawings.

The tenant model 227 may be trained on tenant training data comprising the marketing positions, tenant financial information, lease terms, business descriptions, and tenant credit ratings.

The document model 229 may be trained on property data and property data sources 110.

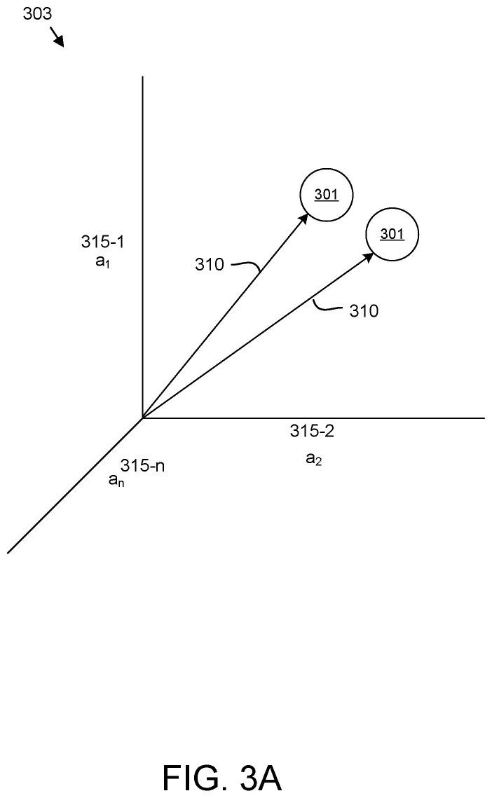

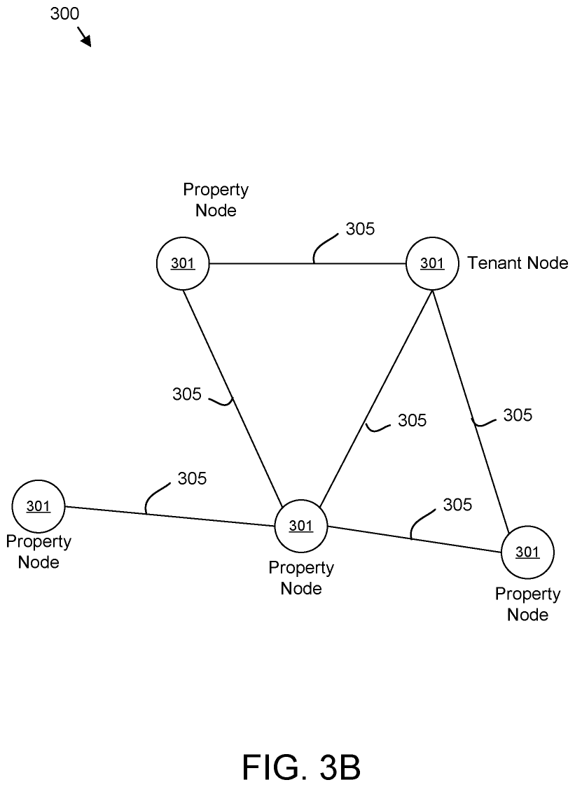

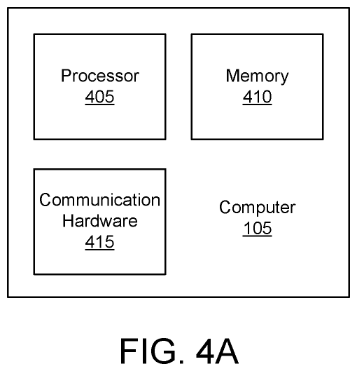

The omni model 231 may integrate at least one of the comparable property model 203, the demographic model 205, the pre-marketing letter model 207, the maintenance model 209, the financial model 211, the visual model 213, the rendering model 215, the summary model 217, the highlights model 219, the location model 221, the assessment model 223, the plans model 225, the tenant model 227, the document model 229, and the GNN 300. The GNN 300 is described hereafter in FIG. 3B.

FIG. 2B is a schematic block diagram illustrating one embodiment of property data 201, a property marketing position 241, a large language model 280, and a cross-encoder model 290. The property data 201 may be organized as a data structure in the memory. The property data 201 comprising at least one of a price-per-square-foot, a capitalization rate, a net operating income, a loss term, property descriptions, similarity scores, price points, marketing positions, census data, population statistics, economic indicators, consumer data, property condition reports, maintenance records, capital expenditure data, building system ages, NOI, property rent rolls, property operating expenses, property lease rates, property cap rate data, property photographs, property aerial images, property site plans, property reference imagery, property GIS data, property aerial images, property coordinates, property points of interest data, property location maps, property building sizes, property parcel information, property construction details, property zoning information, property special features, property floor plans, property site plans, property architectural drawings, property engineering drawings, property tenant financial information, property lease terms, property business descriptions, and property tenant credit ratings.

The property marketing position 241 may describe how a given property is marketed. The property marketing position 241 may specify a specific strategy and one or more tactics for marketing the given property. The property marketing position 241 may be unique to each given property. As a result, the property marketing position 241 may drive the generation of the analyses, reports, profiles, and documents relating to the given property.

Property descriptions may comprise at least one of the elements of Table 1.

TABLE 1

Property transactions
MLS listings
Property specifications
Market research reports
Commercial property records
Tax assessment records

The LLM 280 may generate a natural language description from a property node as will be described hereafter.

The cross-encoder model 290 may be used to score subject/comparable pairs as is described hereafter.

FIG. 2C is a schematic block diagram illustrating one embodiment of comparable information 250. The comparable information 250 may be organized as a data structure in the memory. In addition, the comparable information 250 may be printed, rendered as an electronic document, rendered as a video presentation, rendered as an audio presentation, and the like. In the depicted embodiment, the comparable information 250 includes at least one subject property 249, comparable properties 251, the comparative market analysis 253, a property demographic profile 255, a pre-marketing letter 257, a property maintenance assessment 259, a property financial summary 261, a property visual arrangement 263, a property marketing document 265, a property executive summary 267, property investment highlights 269, a property location map 271, a property assessment 273, property plans 275, property tenant profiles 277, a comparable properties document 281, at least one subject/comparable pair 283, a distinct document number 285, property price points 286, and a property market position 241.

The comparable properties 251 may identify similar properties to a given property based on the market similarity of the comparable properties to the given property. In one embodiment, the comparable properties are similar to the given property within a property graph.

The comparative market analysis 253 may comprise the comparable properties 251, property price points 286, and/or a property market position 241 based on the comparable properties 251.

The property demographic profile 255 may comprise a selected arrangement of census data, population statistics, economic indicators, and consumer data.

The pre-marketing letter 257 may be generated on a specified broker letterhead.

The property maintenance assessment 259 may comprise a selected arrangement of at least one of current condition, required repairs, and future expenses.

The property financial summary 261 may comprise a selected arrangement of at least one of property NOI, a property cap rate analysis, a property cash flow projection, and property investment return metrics.

The property visual arrangement 263 may comprise an arrangement of selected images of the given property.

The property marketing document 265 may comprise a broker opinion of value (BOV)/request for proposal (RFP) formatted as at least one of a formal letter, a brochure, and a presentation. A property marketing document may be broker curated.

The property executive summary 267 may comprise an arrangement of selected property key features, property financial metrics, and a property investment opportunity.

The property investment highlights 269 may comprise an arrangement of selected property financial data, property features, property market advantages, and property competitive position.

The property location map 271 may comprise a selected arrangement of at least one of the property GIS data, the property aerial images, property coordinates, property points of interest data.

The property assessment 273 may comprise a selected arrangement of at least one of property building size, property parcel information, property construction details, property zoning information, and property special features.

The property plans 275 may comprise a selected arrangement of at least one of property floor plans, property site plans, property architectural drawings, and property engineering drawings.

The property tenant profile 277 may comprise a selected arrangement of at least one of property tenant financial information, property lease terms, property business descriptions, and property tenant credit ratings.

The comparable properties document 281 may be generated for the comparable properties 251. At least of one of the following may be generated for the comparable properties 251 as shown in Table 2.

TABLE 2

Demographic profile
Population density
Population growth
Income level analysis
Consumer spending analysis
Business environment analysis
Economic outlook analysis
Consumer behavior patterns
Business environment analysis
Business growth analysis

Each subject/comparable pair 283 specifies at least one subject property 249 and one comparable property 251. The comparable information 250 comprises a plurality of subject/comparable pairs 283.

The distinct document number 285 is a number of documents in the comparable information 250. In one embodiment, the distinct document number 285 specifies a number of broker-curated documents. For example, the distinct document number 285 may be incremented for each broker-curated document that mentions a subject/comparable pair 283.

The property price points 286 specify price ranges and/or price points of the subject property 249 in various scenarios.

FIG. 2D is a schematic block diagram of the property data 201. The property data 201 may be organized as a data structure in the memory. In addition, the property data 201 may be printed, rendered as an electronic document, rendered as a video presentation, rendered as an audio presentation, and the like. In the depicted embodiment, the property data 201 includes a property node 301 and at least one of the corresponding comparative market analysis 253, property demographic profile 253, pre-marketing letter 257, property maintenance assessment 259, property financial summary 261, property visual arrangement 263, property marketing document 265, property executive summary 267, property investment highlights 269, property location map 271, property assessment 273, property plans 275, property tenant profiles 277, a comparable properties document 281, an estimate of price-per-square foot 291, a capitalization rate 293 for the property node 301, estimated and/or actual net operating income 295 for the property node 301, and a loss term 297 for the property node 301.

FIG. 3A is a schematic diagram illustrating one embodiment of a property graph 303. The property graph 303 may be a heterogenous property graph 303. The property graph 303 includes a plurality of n axes a 315. For simplicity in the depicted embodiment n is three. The axes 315 may be elements of the property data 201. For a given property node 301, the property data 201 defines a feature vector 310 that locates the property node 301 in the property graph 303.

FIG. 3B is a schematic diagram illustrating a GNN 300. The GNN 300 comprises a plurality of nodes 301 from the property graph 303. A node 301 may be a property node 301. In addition, a node 301 may be defined as at least one of a tenant node 301, an owner node 301, a broker node 301, a lender node 301, a transaction node 301, a submarket node 301, a zoning district node 301, a point-of-interest node 301, a school district node 301, an opportunity-zone node 301, and a macro-market node 301.

The edges 305 comprise at least a co-citation comparable edge 305. The co-citation comparable edge 305 connects nodes 301 that are a subject property 249 and a comparable property 251 in a subject/comparable pair 283.

The edges 305 may comprise a located-in edge 305, a zoned-as edge 305, an occupies edge 305, an owns edge 305, a traded-in edge 305, a brokered edge 305, a financed edge 305, a near edge 305, a shared-broker edge 305, a shared-tenant edge 305, a shared-owner edge 305, and a k-nearest-neighbor edge 305.

The located-in edge 305 connects nodes 301 that are located in a same geographic area. The zoned-as edge 305 connects nodes 301 that are similarly zoned. The occupies edge 305 connects nodes 301 that are occupied by a same entity. The owns edge 305 connects nodes 301 that are owned by a same owner. The trade-in edge 305 connects nodes 301 are traded-in. The brokered edge 305 connects nodes 301 that are brokered. The financed edge 305 connects nodes 301 that are financed. The near edge 305 connects nodes 301 that are within a specified distance. The shared-broker edge 305 connects nodes 301 that are brokered by a same entity. The shared-tenant edge 305 connects nodes 301 that are occupied by a same tenant. The shared-owner edge 305 connects nodes 301 that are owned by a same entity.

The k-nearest-neighbor edge 305 connects the k most near distance nodes 301, where k is a specified integer. The k-nearest-neighbor edge 305 may be in addition to the near edge 305.

The GNN 300 may be selected from the group consisting of: a graph convolutional network, a Graph Sample and Aggregate network (GraphSAGE), a graph attention network, a relational graph convolutional network, a heterogeneous graph attention network, a heterogeneous graph transformer, and a graph transformer with relative temporal encoding. The GNN 300 may be pretrained by at least one of a graph contrastive objective applied to two augmented views of the property graph, a non-contrastive bootstrap objective using an online and a target encoder, a mutual-information-maximization objective between node-level patches and a graph-level summary, a link-prediction objective on masked edges, and a group-discrimination objective.

The GNN 300 employs message passing parameters conditioned on a type of an edge 305 and on types of source and destination property nodes 301. The types may be heterogeneous. In one embodiment, the GNN 300 inductively produces a property node 301 that was not present at training time without retraining the GNN 300.

A node 301 may send a message to neighbor nodes 301. The message may be a function of the node's data such as the property data 201. The message

$${m}_{uv}^{( k )}$$

for a neighbor node u 301 of node v 301 at a given layer k may be calculated using Equation 1, where

$${h}_{u}^{( k - 1 )}$$

is the feature vector 310 for node u 301,

$${h}_{v}^{( k - 1 )}$$

is feature vector 310 for node v 301, and eᵤᵥ represents edge features including weights and/or types.

$${m}_{uv}^{( k )} = MSG ( {h}_{u}^{( k - 1 )} , {h}_{v}^{( k - 1 )} , {e}_{uv} ) \qquad Eq . 1$$

The GNN 300 may aggregate messages

$${m}_{uv}^{( k )} .$$

In one embodiment, the messages are aggregated using Equation 2.

$${M}_{v}^{( k )} = {\sum }_{u ∈ {N}_{( v )}} {m}_{uv}^{( k )} \qquad Eq . 2$$

A mean, a maximum, a minimum, and the like may be calculated for the aggregated messages

$${M}_{v}^{( k )} .$$

Using the aggregated messages

$${M}_{v}^{( k )}$$

the node v 301 may be updated as shown in Equation 3.

$${h}_{v}^{( k )} = UPDATE ( {h}_{v}^{( k - 1 )} , {M}_{v}^{( k )} ) \qquad Eq . 3$$

The updated node v 301 is the input for the next layer of the GNN 300. In one embodiment, for each layer, a node 301 receives messages from farther away in the GNN 300. As a result, the GNN 300 may be selectively searched. In addition, the GNN 300 may be efficiently searched.

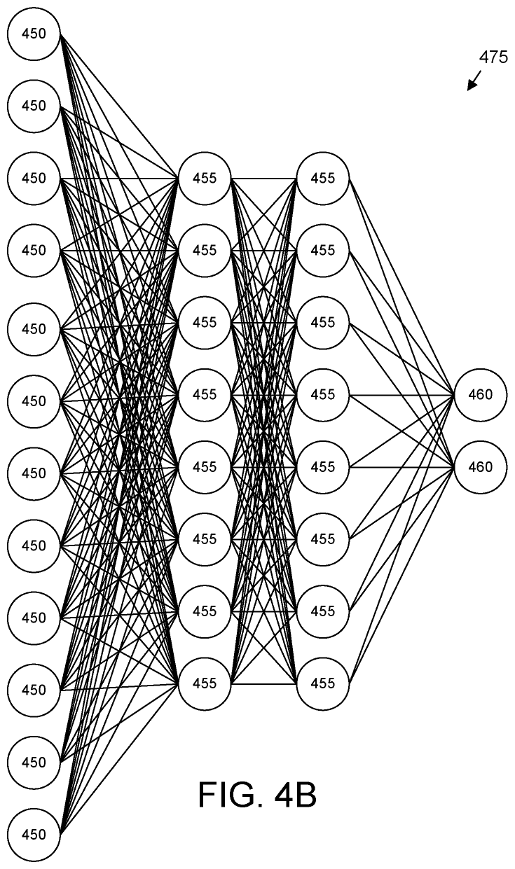

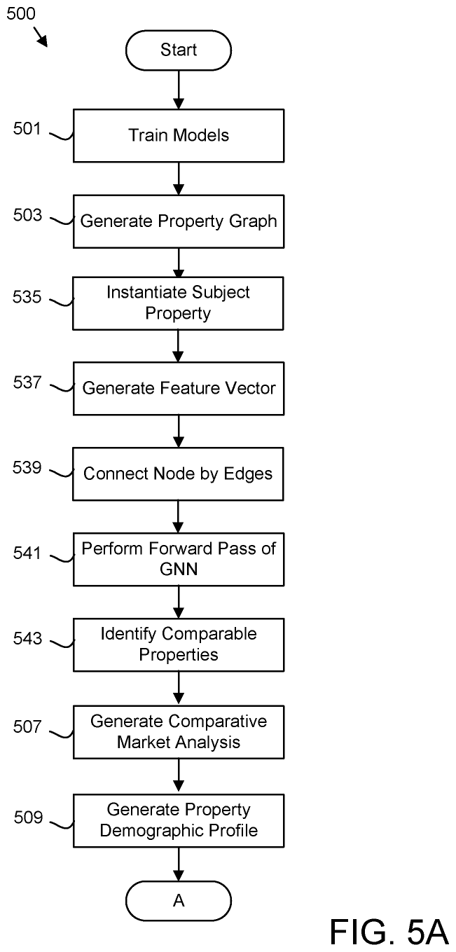

FIG. 4A is a schematic block diagram illustrating one embodiment of a computer 105. In the depicted embodiment, the computer 105 includes a processor 405, a memory 410, and communication hardware 415. The memory 410 may store code and data. The processor 405 may execute the code and process the data. The computer 105 may communicate with other devices through the communication hardware 415.

FIG. 4B is a schematic block diagram illustrating one embodiment of a neural network 475. In the depicted embodiment, the neural network 475 includes input neurons 450, hidden neurons 455, and output neurons 460. The neural network 475 may be organized as a large language model, a convolutional neural network, a recurrent neural network, long short term memory (LSTM) network, a transformer, and the like.

The neural network 475 may be trained with training data. The neural network 475 may be trained using one or more learning functions while applying the training data to the input neurons 450 and known result values for the output neurons 460.

Subsequently, the neural network 475 may receive actual data at the input neurons 450 and make predictions at the output neurons 460 based on the actual data.

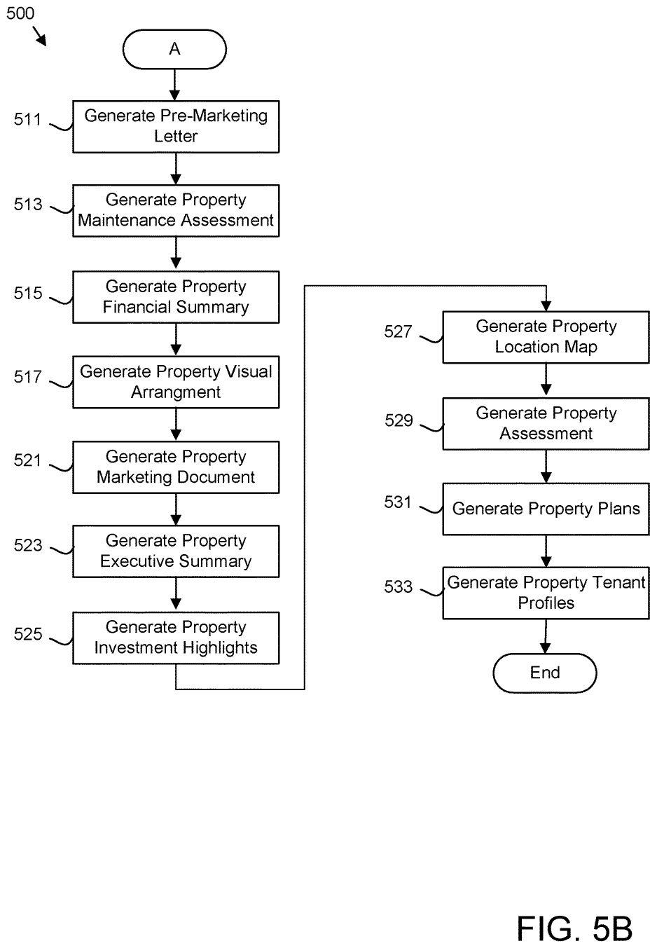

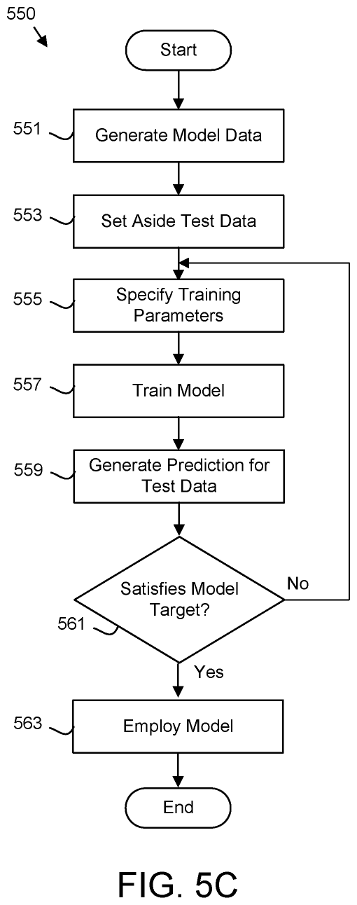

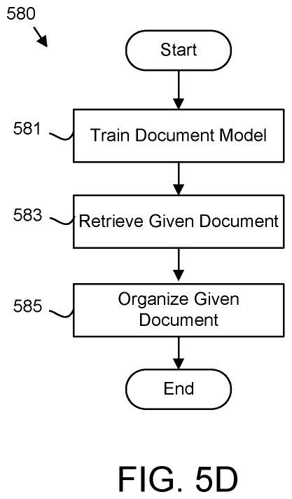

FIGS. 5A-B is a flow chart diagram illustrating one embodiment of a market analysis method 500. The method 500 may generate the comparative market analysis 253 and other analyses, profiles, and/or documents described therein.

The method 500 trains 501 the models 101 as will be described hereafter in FIG. 5B. Each model 101 may be trained separately. Each model 101 may be trained on separate data. Alternatively, each model 101 may be trained on the same data.

The method 500 generates 503 the property graph 303 for a plurality of property nodes 301 from property data 201, wherein nearness indicates market similarity. The property graph 303 represents property descriptions as the property nodes 301 in a multidimensional space and the distance between the property nodes 301 specifies the market similarity.

In one embodiment, the method 500 instantiates 535 the subject property 249 in the property graph 303 as a new property node 301 using selected elements of the comparable data 201. All nodes 301 may be instantiated from property data 201 and/or the property data structure 103. A subject property 249 and comparable properties 251 may be extracted from the ingested data and resolved into property nodes 301. Each comparable property 251 may be resolved to a property node 301 using at least one of address normalization, parcel-identifier matching, and entity disambiguation. Duplicate property nodes 301 may be merged. The subject property 249 and each comparable property 251 may form a subject/comparable pair 283. The method 500 further generates 537 the feature vector 310 for the new property node 301 and/or for each node 301.

The method 500 connects 539 nodes 301 including the new property node 301 by edges 305 to other nodes 301 in the GNN 300 based on the comparable information 250.

At least one edge 305 may be a co-citation comparable edge 305. The co-citation comparable edge 305 may be constructed by ingesting the property marketing document 265. In addition, the co-citation comparable edge 305 may be constructed by ingesting the comparable information 250 and/or property data 201. Edges 305 are inserted to connect 539 each subject/comparable pair 283.

The new property node 301 may be connected 539 to other property nodes 301 with any appropriate type of edge 305. For example, property nodes 301 that share an owner may be connected 539 with a shared-owner edge 305. At least one edge 305 may be tagged with a temporal validity interval that specifies a maximum valid time interval. Message passing in the GNN 300 during inference for a query timestamp is constrained to edges 305 whose validity interval includes a time at or prior to the query timestamp.

In one embodiment, a co-citation comparable edge 305 is weighted as function of the distinct document number 285 for the subject/comparable pair 283. Each co-citation comparable edge 305 may be further weighted by at least one of document recency, broker reputation, and asset-class specificity.

The method 500 performs 541 a forward pass of the GNN 300 over a sampled neighborhood of property nodes 301 to produce an embedding of the new property node 301 in the GNN 300. The forward pass may employ Equations 1-3 or the like.

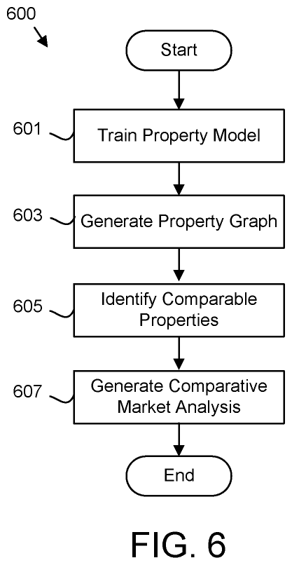

The method 500 identifies 543 comparable properties 251 from the property nodes 301 in the GNN 300. The identification 543 is described in more detail in FIG. 6 step 605.

Alternatively, comparable properties 251 may be identified based on nearness of the corresponding feature vectors 310. For example, comparable properties 251 may be identified 543 for the given property node 301 based on the market similarity of the comparable properties to the given property nodes 301 within the property graph 303. The comparable properties 251 may be identified as the K-nearest neighbors of the plurality of property descriptions to the given property description in the property graph. In addition, the comparable properties 251 may be identified from a subset of the plurality of property descriptions selected based on locality-sensitive hashing. In a certain embodiment, the comparable properties 251 are identified from a subset of the plurality of property descriptions selected based on distance-weighted relevance scoring. In one embodiment, the comparable properties 251 are identified from a subset of the plurality of property descriptions selected based on dimensionality reduction.

The method 500 generates 507 the comparative market analysis 253. In one embodiment, copyrighted elements are removed from the comparative market analysis 253.

The method 500 further generates 509 the property demographic profile 255 using the demographic model 205 in response to the property market position 241 and further based on census data, population statistics, economic indicators, consumer data, and property GIS data.

The method 500 generates 511 the pre-marketing letter 257 using the pre-marketing model 207 in response to the property market position 241 and the property demographic profile 255.

The method 500 generates 513 the property maintenance assessment 259 using the maintenance model 209 in response to property condition reports, property maintenance records, property capital expenditure data, and property building system ages for the given property.

The method 500 generates 515 the property financial summary 261 using the financial model 211 in response to the property maintenance assessment, property financial statements, property rent rolls, property operating expenses, property lease rates, and property cap rate data.

The method 500 generates 517 the property visual arrangement 263 using the visual model 213 in response to the property marketing position 241, property photographs, property aerial images, property site plans, and property reference imagery.

The method 500 generates 521 the property marketing document 265 using the rendering model 215 in response to the property marketing position 241, the property demographic profile 255, the property maintenance assessment 259, the property financial summary 261, and the property visual arrangement 263.

The method 500 generates 523 the property executive summary 267 using the summary model 217 in response to the property marketing position 241, the property demographic profile 255, the property maintenance assessment 259, the property financial summary 261, the property visual arrangement 263, and the property marketing document 265.

The method 500 generates 525 the property investment highlights 269 using the highlights model 219 in response to the property marketing position 241, the property financial summary 261, and the property visual arrangements 263.

The method 500 generates 527 the property location map 271 using the location model 221 in response to the property marketing position 241, the property executive summary 267, and the property investment highlights 269, and further based on the property GIS data.

The method 500 generates 529 the property assessment 273 using the assessment model 223 in response to the property marketing position 241, the property building size, the property parcel information, the property construction details, the property zoning information, and the property special features.

The method 500 generates 531 the property plans 275 using the plans model 225 in response to the property marketing position 241, the property floor plans, the property site plans, the property architectural drawings, and the property engineering drawings.

The method 500 generates 533 the property tenant profile 277 using the tenant model 227 in response to the property marketing position, the property tenant financial information, the property lease terms, the property business descriptions, and the property tenant credit ratings.

FIG. 5C is a flow chart diagram illustrating one embodiment of a model training method 550. The method 550 starts and in one embodiment, the method 550 generates 551 model training data. The model training data may be historic data. In one embodiment, real-time model training data is added.

The method 550 may set aside 553 a portion of the model training data as test data. The test data will not be used to train the model.

The method 550 may specify 555 the training parameters. The model is trained 557 using the model training data in accordance with the training parameters.

The method 550 generates 559 a prediction from the model with the test data. The method 550 determines 561 whether the prediction satisfies the target model. If the prediction does not satisfy the target model, the training parameters are modified 555 and the model is again trained 557. If the prediction satisfies the target model, the trained model is employed 563 and the method 550 ends.

FIG. 5D is a flow chart diagram illustrating one embodiment of a document organization method 580. The method 580 may organize a given document in the property data structure 103 using the document model 229.

The method 580 trains 581 the document model 229. In addition, the method 580 retrieves 583 a given document using the document model 229. The method 580 may organize 585 the given document in the property data structure 103 using the document model 229.

FIG. 6 is a flow chart diagram illustrating one embodiment of a market analysis method 600. The method 600 may generate the comparative market analysis 253 and other analyses, profiles, and/or documents described therein. The method 600 may be performed by the system 100 and/or elements thereof.

The method 600 trains 601 the comparable property model 203. In one embodiment, the GNN 300 is trained. The GNN 300 may be trained 601 in a self-supervised pretraining stage without labels external to the property graph 303. The GNN 300 may be further trained in a supervised fine-tuning stage with positive pairs of comparable properties 251 and/or subject/comparable pairs 283 identified from property marketing documents 265. The GNN 300 may be trained 601 to assign higher similarity to positive pairs of comparable properties 251 and/or subject/comparable pairs 283. In one embodiment, the GNN 300 is trained 601 to assign higher similarity to the positive pairs of comparable properties 251 and/or subject/comparable pairs 283 than to random or hard-mined negative pairs of comparable properties 251.

The method 600 generates 603 the property graph 303 for a plurality of property nodes 301 from property data 201 including the feature vectors 310, wherein nearness indicates market similarity. The property graph 303 represents property descriptions such as property data 201 as the property nodes 301 in a multidimensional space and the distance between the property nodes 301 specifies the market similarity. In one embodiment, only a given property node 301 is added to the property graph 303. The given property node 301 may be a new property node 301. The given property node 301 may be a property node 301 of interest.

The method 600 identifies 605 comparable properties 251 for the given property node 301 using the GNN 300. The comparable properties 251 may be identified 605 by retrieving candidate comparable properties 251 from an approximate-nearest-neighbor index over precomputed property nodes 301 in property graph 303. The property graph 303 may be updated using the GNN 300.

In one embodiment, the GNN 300 is updated over a given number of layers to identify 605 the comparable properties 251. The method 600 may further re-rank the identified 605 candidate comparable properties 251 using the cross-encoder model 290 to score subject/comparable pairs 283 jointly.

By using the GNN 300 to identify 605 comparable properties 251, the embodiments improve the efficiency, efficacy, and function of identifying 605 comparable properties 251. The GNN 300 is substantially more efficient than performing a pair-wise search of subject/comparable pairs 283. In addition, using the GNN 300 improves the efficacy of identifying 605 comparable properties 251 by identifying comparable properties 251 that are not listed in comparable information 250. For example, edges 305 other than the co-citation comparable edge 305 may be used to identify 605 comparable properties 251. As a result, more comparable properties 251 are available for a comparative market analysis 253. The function of identifying 605 comparable properties 251 is enhanced.

The method 600 generates 607 the comparative market analysis 253 for the comparable properties 251. The comparative market analysis 253 may comprise the comparable properties 251, property price points 286, and a property market position 241 based on the comparable properties 251. In one embodiment, copyrighted elements are removed from the comparative market analysis 253.

In one embodiment, the method 600 generates 607 at least one of a property demographic profile 253, a pre-marketing letter 257, a property maintenance assessment 259, a property financial summary 261, a property visual arrangement 263, a property marketing document 265, a property executive summary 267, property investment highlights 269, a property location map 271, a property assessment 273, property plans 275, and property tenant profiles 277.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method comprising:
training, by use of a processor, a comparable property model on property data, wherein the comparable property model comprises a graph neural network (GNN) with nodes and edges, each node is one of a property node, a tenant node, an owner node, a broker node, a lender node, a transaction node, a submarket node, a zoning district node, a point-of-interest node, a school district node, an opportunity-zone node, and a macro-market node, the edges comprising at least a co-citation comparable edge;
generating a property graph for a plurality of property descriptions and a given property description using the property model, wherein nearness indicates market similarity;
identifying comparable properties for the given property based on the market similarity of the comparable properties in the GNN; and
generating a comparative market analysis comprising the comparable properties, property price points, and a property market position based on the comparable properties.

2. The method of claim 1, wherein training the comparable property model comprises:
training in a self-supervised pretraining stage without labels external to the property graph;
training in a supervised fine-tuning stage with positive pairs of comparable properties identified from property marketing documents, wherein the comparable property model assigns higher similarity to positive pairs of comparable properties.

3. The method of claim 1, wherein the co-citation comparable edge is constructed by:
ingesting property marketing documents;
extracting a subject property and comparable properties cited by the property marketing documents;
resolving each comparable property to a property node;
inserting an edge for each subject/comparable pair; and
weighting the co-citation comparable edge as a function of a distinct document number for the subject/comparable pair.

4. The method of claim 3, wherein each co-citation comparable edge is further weighted by at least one of document recency, broker reputation, and asset-class specificity.

5. The method of claim 3, wherein each comparable property is resolved to a property node using at least one of address normalization, parcel-identifier matching, and entity disambiguation.

6. The method of claim 1, wherein at least one edge is tagged with a temporal validity interval, and message passing during inference for a query timestamp is constrained to edges whose validity interval includes a time at or prior to the query timestamp.

7. The method of claim 1, wherein the GNN is selected from the group consisting of: a graph convolutional network, a Graph Sample and Aggregate network (GraphSAGE), a graph attention network, a relational graph convolutional network, a heterogeneous graph attention network, a heterogeneous graph transformer, and a graph transformer with relative temporal encoding.

8. The method of claim 1, wherein the GNN is pretrained by at least one of a graph contrastive objective applied to two augmented views of the property graph, a non-contrastive bootstrap objective using an online and a target encoder, a mutual-information-maximization objective between node-level patches and a graph-level summary, a link-prediction objective on masked edges, and a group-discrimination objective.

9. The method of claim 1, wherein identifying comparable properties further comprises retrieving candidate comparable properties from an approximate-nearest-neighbor index over precomputed property nodes in property graph, and re-ranking the retrieved candidate comparable properties using a cross-encoder model that scores subject/comparable pairs jointly.

10. The method of claim 1, wherein ingesting a subject property comprises:
encoding features using a model comprising at least one of a demographic model, a pre-marketing letter model, a maintenance model, a financial model, a visual model, a rendering model, a summary model, a highlights model, a location model, an assessment model, a plans model, a tenant model, a document model, and an omni model;
instantiating the subject property in the property graph as a new property node using property data comprising at least one of a comparative market analysis, a property demographic profile, a pre-marketing letter, a property maintenance assessment, a property financial summary, a property visual arrangement, a property marketing document, a property executive summary, property investment highlights, a property location map, a property assessment, property plans, property tenant profiles, and a comparable properties document;
generating a feature vector for the new property node;
connecting the new property node by edges to other property nodes based on the comparable information;
performing a forward pass of the GNN over a sampled neighborhood of property nodes to produce an embedding of the new property node;
identifying comparable properties from the property nodes in the GNN.

11. The method of claim 1, wherein the comparative market analysis further comprises a natural language description generated by a large language model based on the GNN.

12. The method of claim 1, wherein the co-citation comparable edge is further modified by at least one of document recency, broker reputation, and asset-class specificity.

13. The method of claim 1, wherein each edge is at least one of the co-citation comparable edge, a located-in edge, a zoned-as edge, an occupies edge, an owns edge, a traded-in edge, a brokered edge, a financed edge, a near edge, a shared-broker edge, a shared-tenant edge, a shared-owner edge, and a k-nearest-neighbor edge.

14. The method of claim 1, wherein the GNN comprises message passing parameters conditioned on edge type and on source and destination node types, and produces a property node that was not present at training time without retraining the GNN.

15. The method of claim 1, wherein the property data comprises at least one of the property descriptions, the similarity scores, the price points, the property marketing position, the census data, the population statistics, the economic indicators, the consumer data, the property condition reports, the maintenance records, the capital expenditure data, the building system ages, the NOI, the property rent rolls, the property operating expenses, the property lease rates, the property cap rate data, the property photographs, the property aerial images, the property site plans, the property reference imagery, the property GIS data, the property aerial images, property coordinates, property points of interest data, the property location map, the property building size, the property parcel information, the property construction details, the property zoning information, the property special features, the property floor plans, the property site plans, the property architectural drawings, the property engineering drawings, the property tenant financial information, the property lease terms, the property business descriptions, and the property tenant credit ratings, and wherein the property data sources comprise at least one of multiple listing service (MLS) listings, government property records, census data, tax assessment records, GIS databases, lease agreements, and commercial property records.

16. The method of claim 1, the method further comprising generating at least one of a property demographic profile, a pre-marketing letter, a property maintenance assessment, a property financial summary, a property visual arrangement, a property marketing document, a property executive summary, property investment highlights, a property location map, a property assessment, property plans, and property tenant profiles.

17. The method of claim 1, the method further comprising predicting property data for a property node using an auxiliary regression head, the property data comprising at least one of a price-per-square-foot, a capitalization rate, a net operating income, and a loss term.

18. An apparatus comprising:
a processor executing code stored on a memory to perform:
training a comparable property model on property data, wherein the comparable property model comprises a graph neural network (GNN) with nodes and edges, each node is one of a property node, a tenant node, an owner node, a broker node, a lender node, a transaction node, a submarket node, a zoning district node, a point-of-interest node, a school district node, an opportunity-zone node, and a macro-market node, the edges comprising at least a co-citation comparable edge;
generating a property graph for a plurality of property descriptions and a given property description using the property model, wherein nearness indicates market similarity;
identifying comparable properties for the given property based on the market similarity of the comparable properties in the GNN; and
generating a comparative market analysis comprising the comparable properties, property price points, and a property market position based on the comparable properties.

19. The apparatus of claim 18, wherein training the comparable property model comprises:
training in a self-supervised pretraining stage without labels external to the property graph;
training in a supervised fine-tuning stage with positive pairs of comparable properties identified from property marketing documents, wherein the comparable property model assigns higher similarity to positive pairs of comparable properties.

20. A computer readable program product comprising a non-transitory computer medium storing code executed by a processor to perform:
training a comparable property model on property data, wherein the comparable property model comprises a graph neural network (GNN) with nodes and edges, each node is one of a property node, a tenant node, an owner node, a broker node, a lender node, a transaction node, a submarket node, a zoning district node, a point-of-interest node, a school district node, an opportunity-zone node, and a macro-market node, the edges comprising at least a co-citation comparable edge;
generating a property graph for a plurality of property descriptions and a given property description using the property model, wherein nearness indicates market similarity;
identifying comparable properties for the given property based on the market similarity of the comparable properties in the GNN; and
generating a comparative market analysis comprising the comparable properties, property price points, and a property market position based on the comparable properties.
